(19) United States
(12) Patent Application Publication
(10) Pub. No.: US 2003/0125087 A1
(43) Pub. Date: Jul. 3, 2003

(54) Wireless base station device, wireless communication system, and communication control method

(75) Inventor: Megumi Shimizu, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/300,746

(22) Filed: Nov. 21, 2002

(30) Foreign Application Priority Data
Dec. 27, 2001 (JP) 2001-397953

(51) Int. Cl. H04Q 7/20

(52) U.S. Cl. 455/561; 455/453

(57) ABSTRACT

Provided is a wireless base station device which can effectively utilize DCF and PCF. In a wireless base station device which controls access requests from mobile terminals belonging thereto by the DCF (Distributed Coordination Function) and controls access request from the mobile terminals by the PCF through polling due to an increase in a wireless LAN traffic, when the state where the average data size of data frame transmitted/received to/from the mobile terminals exceeds a certain value continues for a prescribed time, or the state where the accumulated data rate calculating section is higher than a prescribed threshold value, continues for a prescribed time, the communication control system is switched from the DCF to the PCF. Therefore, the time of occupying the wireless medium can be more effectively utilized by using both the DCF and the PCF, compared to the case of using only the DCF as the communication state which has a possibility of collision and requires transmission time for RBO time and DIFS time every time.

### BACKGROUND OF THE INVENTION

1. Field of the Invention

The present invention relates to a wireless base station device, a wireless communication system and a communication control method which control transmission/reception of data between the wireless base station and mobile terminals using DCF (Distributed Coordination Function) and PCF (Point Coordination Function) defined by IEEE802.11.

2. Description of the Related Art

FIG. 2 shows a system structure of an infrastructure network system defined by IEEE802.11. As shown in FIG. 2, the minimum unit of a wireless LAN network is referred to as a BSS (Basic Service Set) 3. An AP (Access Point) 1 in the BSS 3 periodically performs broadcast transmission (transmission to unspecific number of receivers without designating the address where data is to be transmitted) of beacon frame, which is the information for retrieving each STA, containing information for each of the STAs (stations) 2A and 2B to synchronize with the AP 1. Then, each of the STAs 2A and 2B, after receiving the beacon frame, requests authentication to the AP 1 at the time of starting communication. After receiving authentication from the AP 1 and then completing processing for belonging to the AP 1, it becomes possible to perform exchange of data frame between the AP 1. Each of the STAs 2A and 2B within the BSS 3 in an infrastructure network also performs communication with the STAs via the AP 1.

There are two types of methods for controlling the AP (Access Point) defined by IEEE802.11, which is a standard model for a wireless LAN. One is DCF (Distributed Coordination Function) and the other is PCF (Point Coordination Function) The DCF is essential in the system while the PCF is considered as an optional function.

The DCF is a communication control system in which the AP 1 and the AP 2 have the equal transmission rights to each other. In the DCF, each of the AP 1 or the STA 2 to which transmission is requested waits transmission for a period obtained by adding random-number time referred to as RBO (Random Back Off) to a fixed time referred to as DIFS (Distributed Interframe Space) counted from the start of idling in a wireless medium. On the contrary, the PCF is a system in which the AP 1 performs transmission control of the STA 2. The AP 1 performs distributing of the transmission rights referred to as polling and the STA 2 can achieve frame transmission only when it obtains a transmission right from the AP 1. At this time, if the AP 1 carries transmission data for the STA 2, frame transmission can be also performed together with polling. The interval of frame transmission in the PCF is defined to be a shorter time than the DIFS, which is referred to as SIFS (Short Interframe Space). In IEEE802.11, each parameter for achieving the PCF is defined. However, there is no definition over the usage of either the DCF or the PCF or the recommended values for each parameter so that the detail depends on the state when actually used.

As a conventional example 1 related to the technical field similar to the present invention, Japanese Patent Application Laid-open Hei 8-274788 discloses “Multiple Access Method”. In the conventional example, in a multiple access method which performs packet communication by one wireless communication medium between a plurality of terminals and a wireless base station used by both sides, the system is selected depending on the reception error rate of the packet signals received by the wireless base station. When the reception error rate is small, a multiple access system in which collision can be generated is used and when the reception error rate is large, a multiple access system in which no collision can be generated is used.

Also, as a conventional example 2 related to the technical field similar to the present invention, Japanese Patent Application Laid-open Hei 5-48610 discloses “Wireless Communication System”. In the conventional example, a wireless communication system with a master station and a plurality of slave stations comprises: a unit for counting the number of collisions of transmission requests transmitted from a plurality of slave stations when communication is performed by a contention system in which a base station performs transmission/reception of data to/from a slave station after responding to the slave station upon receiving a transmission request from the slave station; a unit for switching to polling system communication through transmitting protocol conversion command to each slave station when the number of collisions per unit time exceeds the prescribed time set beforehand; a unit for counting the invalid slot number having no data in the time slot received from the slave stations in a state where communication is performed by polling system in which polling signals containing time slot information are transmitted to each slave station and each slave station transmits data in order according to the time slot; and a unit for switching to contention system communication through transmitting protocol conversion command to each slave station when the number of collisions per unit time exceeds the prescribed value set beforehand.

However, when comparing to the PCF system with a system refereed to as a best-effort type using the DCF in which transmission right is obtained by random-number value based on RBO, there are tremendous possibilities in the PCF system in regards to its usage such as being able to guarantee a certain level of service for the STA 2 depending on the applying method of the system by the PCF since the PCF is a centralized control function in which the AP 1, as a main body, distributes the transmission rights to the STA 2.

It is also possible to use a communication control method in which the PCF and the DCF are distributed by fixed period. However, as described earlier, there is no measure to define the proportion. Thus, although it depends on the set condition, there may be cases with troubles in services such as deterioration of traffic because of an increase in a necessary packet by using the PCF.

Further, the above-described conventional examples 1 and 2 use the reception error rate when judging the timing for switching the system from the collision access system to the non-collision access system. However, the increase in the reception error rate does not directly reflect the increase of traffic on the wireless medium. For example, it is possible that the reception error rate increases by an interference wave.

Also, in the conventional examples 1 and 2, it is only when there are frequent transmission collisions generated between the slave stations that the system is switched to the non-collision access system. However, in a wireless LAN, in the case where the STA 2 retransmits data frame by the DCF due to generation of collision, the random-number time itself as a part of waiting time as described becomes larger compared to that at the time of initial transmission of data frame. Therefore, the waiting time of the STA 2 becomes further longer so that there generates less opportunities for achieving transmission.

### SUMMARY OF THE INVENTION

The present invention has been designed to overcome the foregoing problems. An object of the invention is to provide a wireless base station device, wireless communication system and a communication control method in which DCF and PCF are effectively utilized by referring to data size and data accumulation rate as indicators to detect the communication state.

In order to achieve the above-described object, a wireless base station device according to one aspect of the present invention has the equal transmission right with a mobile terminal and controls transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates. The communication control system is switched from the distributed control function to the centralized control function when a state where the average data size of data frame transmitted/received to/from the mobile terminal exceeds a certain value continues for a prescribed time.

A wireless base station device according to another aspect of the present invention has the equal transmission right with a mobile terminal and controls transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates. The communication control system is switched from the distributed control function to the centralized control function when the accumulated data rate, which is a proportion of uncompleted transmission number against data transmission request number calculated by the data transmission request number transmitted from the wireless base station device to the mobile terminal and the number of data which has been transmitted to the mobile terminal, is higher than a prescribed threshold value.

A wireless base station device according to still another aspect of the present invention has the equal transmission right with a mobile terminal and controls transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates. The communication control system is switched from the distributed control function to the centralized control function when time corresponding to a frame interval is detected to be a prescribed threshold value or less by monitoring the time corresponding to the frame interval of data frame continuously present on the wireless medium.

A wireless base station device according to a further aspect of the present invention has the equal transmission right with a mobile terminal and controls transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates. At the time of switching the communication control function from the distributed control function to the centralized control function due to an increase in traffic of a wireless medium, when the transmission rights cannot be distributed to all the mobile terminals belonging to the wireless base station device within an effective time in which the centralized control function is allowed to operate, communication control is to be achieved also after the effective time by providing another effective time in which the centralized control function operates.

A wireless base station device according to a still further aspect of the present invention has the equal transmission right with a mobile terminal and controls transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates. At the time of switching the communication control function from the distributed control function to the centralized control function due to an increase in traffic of a wireless medium, the total time required for performing transmission/reception of data to/from all the mobile terminals belonging to the wireless base station device is calculated and communication control is performed by polling having the calculated time as the effective time for centralized control function.

The wireless base station device according to one aspect of the present invention as described comprises an average data size calculating unit for calculating the mean value of transmission/reception data size within a certain time as a unit for detecting a traffic increase in the wireless medium. The communication control system is switched from the distributed control function to the centralized control function when the average data size calculated by the average data size calculating unit is larger than a threshold value.

The wireless base station device according to one aspect of the present invention as described comprises, as a unit for detecting a traffic increase in the wireless medium, an accumulated data rate calculating unit for calculating an accumulated data rate, which is a proportion of uncompleted transmission number against data transmission request number calculated by the data transmission request number transmitted from the wireless base station device to the mobile terminal and the number of data which has been transmitted to the mobile terminal. The communication control system is switched from the distributed control function to the centralized control function when the accumulated data rate calculated by the accumulated data rate calculating unit is larger than a threshold value.

The wireless base station device according to one aspect of the present invention as described comprises, as a unit for detecting a traffic increase in the wireless medium, a timing unit for timing the time corresponding to a frame interval of data frame continuously present on the wireless medium. The communication control system is switched from the distributed control function to the centralized control function when the time corresponding to the frame interval becomes a threshold value or less.

The wireless base station device according to one aspect of the present invention, at the time of using the centralized control function, cancels a mobile terminal in a state of power saving mode from authenticated mobile terminals which belong to the wireless base station device.

In the wireless base station device according to one aspect of the present invention as described, the distributed control function is DCF (Distributed Coordination Function) defined by IEEE802.11; the centralized control function is PCF (Point Coordination Function) defined by the IEEE802.11; and the communication control system is switched from the DCF to the PCF due to an increase in traffic of a wireless LAN.

A wireless communication system according to one aspect of the present invention comprises a mobile terminal and a wireless base station device performing transmission/reception of data to/from the mobile terminal via a wireless medium. The wireless base station device has the equal transmission right with the mobile terminal and controls transmission/reception of data to/from the mobile terminal by, as a control system in a normal state, a communication control system based on a distributed control function which requires a first waiting time as a transmission interval of a data frame which is a unit of data to be transmitted, while controlling transmission/reception of data to/from the mobile terminal by a communication control system based on a centralized control function through polling which requires a second waiting time as a transmission interval of the data frame that is shorter than the first waiting time, through providing an effective time during which the function operates by detecting a traffic increase in the wireless medium when a state where the average data size of data frame transmitted/received to/from the mobile terminal exceeds a certain value continues for a prescribed time.

A wireless communication system according to another aspect of the present invention comprises a mobile terminal and a wireless base station device performing transmission/reception of data to/from the mobile terminals via a wireless medium. The wireless base station device has the equal transmission right with the mobile terminal and controls transmission/reception of data to/from the mobile terminal by, as a control system in a normal state, a communication control system based on a distributed control function which requires a first waiting time as a transmission interval of a data frame which is a unit of data to be transmitted, while controlling transmission/reception of data to/from the mobile terminal by a communication control system based on a centralized control function through polling which requires a second waiting time as a transmission interval of the data frame that is shorter than the first waiting time, through providing an effective time during which the function operates by detecting a traffic increase in the wireless medium when the accumulated data rate, which is a proportion of uncompleted transmission number against data transmission request number calculated by the data transmission request number transmitted from the wireless base station device to the mobile terminal and the number of data which has been transmitted to the mobile terminal, is higher than a prescribed threshold value.

A wireless communication system according to still another aspect of the present invention comprises a mobile terminal and a wireless base station device performing transmission/reception of data to/from the mobile terminals via a wireless medium. The wireless base station device has the equal transmission right with the mobile terminal and controls transmission/reception of data to/from the mobile terminal by, as a control system in a normal state, a communication control system based on a distributed control function which requires a first waiting time as a transmission interval of a data frame which is a unit of data to be transmitted, while controlling transmission/reception of data to/from the mobile terminal by a communication control system based on a centralized control function through polling which requires a second waiting time as a transmission interval of the data frame that is shorter than the first waiting time, through providing an effective time during which the function operates by detecting a traffic increase in the wireless medium when time corresponding to a frame interval is detected to be a prescribed threshold value or less by monitoring the time corresponding to the frame interval of data frame continuously present on the wireless medium.

A wireless communication system according to a further aspect of the present invention comprises a mobile terminal and a wireless base station device performing transmission/reception of data to/from the mobile terminal via a wireless medium. The wireless base station device has the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates. At the time of switching the communication control function from the distributed control function to the centralized control function due to an increase in a traffic of a wireless medium, when the transmission rights cannot be distributed to all the mobile terminals belonging to the wireless base station device within an effective time in which the centralized control function is allowed to operate, communication control is to be achieved also after the effective time by providing another effective time in which the centralized control function operates.

A wireless communication system according to a still further aspect of the present invention comprises a mobile terminal and a wireless base station device performing transmission/reception of data to/from the mobile terminal via a wireless medium. The wireless base station device has the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates. At the time of switching the communication control function from the distributed control function to the centralized control function due to an increase in a traffic of a wireless medium, the total time required for performing transmission/reception of data to/from all the mobile terminals belonging to the wireless base station device is calculated and communication control is performed by polling having the calculated time as the effective time for centralized control function.

In the wireless communication system according to one aspect of the present invention as described, the wireless base station comprises an average data size calculating unit for calculating the mean value of transmission/reception data size within a certain time as a unit for detecting a traffic increase in the wireless medium. The communication control system is switched from the distributed control function to the centralized control function when the average data size calculated by the average data size calculating unit is larger than a threshold value.

In the wireless communication system according to one aspect of the present invention as described, the wireless base station device comprises, as a unit for detecting a traffic increase in the wireless medium, the accumulated data rate calculating unit for calculating an accumulated data rate, which is a proportion of uncompleted transmission number against data transmission request number calculated by the data transmission request number transmitted from the wireless base station device to the mobile terminal and the number of data which has been transmitted to the mobile terminal. The communication control system is switched from the distributed control function to the centralized control function when the accumulated data rate calculated by the accumulated data rate calculating unit is larger than a threshold value.

In the wireless communication system according to one aspect of the present invention as described, the wireless base station device comprises, as a unit for detecting a traffic increase in the wireless medium, a timing unit for timing the time corresponding to a frame interval of data frame continuously present on the wireless medium. The communication control system is switched from the distributed control function to the centralized control function when the time corresponding to the frame interval becomes a threshold value or less.

In the wireless communication system according to one aspect of the present invention as described, at the time of using the centralized control function, the wireless base station device cancels a mobile terminal in a state of power saving mode from authenticated mobile terminals which belong to the wireless base station device.

In the wireless communication system according to one aspect of the present invention, the distributed control function is DCF (Distributed Coordination Function) defined by IEEE802.11; the centralized control function is PCF (Point Coordination Function) defined by the IEEE802.11; and the wireless base station device switches the communication control system from the DCF to the PCF due to an increase in a traffic of a wireless LAN.

A communication control method according to one aspect of the present invention is used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates. The method comprises the step of: switching the communication control system from the distributed control function to the centralized control function when a state where the average data size of data frame transmitted/received to/from the mobile terminal exceeds a constant value continues for a prescribed time.

A communication control method according to another aspect of the present invention is used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame shorter than the first waiting time, through providing an effective time during which the function operates. The method further comprises the step of: switching the communication control system from the distributed control function to the centralized control function when the accumulated data rate, which is a proportion of uncompleted transmission number against data transmission request number calculated by the data transmission request number transmitted from the wireless base station device to the mobile terminal and the number of data which has been transmitted to the mobile terminal, is higher than a prescribed threshold value.

A communication control method according to still another aspect of the present invention is used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates. The method further comprises the step of: switching the communication control system from the distributed control function to the centralized control function when time corresponding to a frame interval is detected to be a prescribed threshold value or less by monitoring the time corresponding to the frame interval of data frame continuously present on the wireless medium.

A communication control method according to a further aspect of the present invention is used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates. The method further comprises the step of: providing another effective time in which the centralized control function operates for achieving communication control when the transmission rights cannot be distributed to all the mobile terminals belonging to the wireless base station device within an effective time in which the centralized control function is allowed to operate, when switching the communication control function from the distributed control function to the centralized control function due to an increase in traffic of a wireless medium.

A communication control method according to a still further aspect of the present invention is used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates. The method further comprises the step of: calculating the total time required for performing transmission/reception of data to/from all the mobile terminals belonging to the wireless base station device for performing communication control by polling having the calculated time as the effective time for centralized control function when switching the communication control function from the distributed control function to the centralized control function due to an increase in a traffic of a wireless medium.

The communication control method according to one aspect of the present invention as described further comprises the steps of: calculating the mean value of transmission/reception data size within a certain time; detecting a traffic increase in the wireless medium through judging whether or not the calculated average data size is larger than a threshold value; and switching the communication control system from the distributed control function to the centralized control function when the mean value is larger than the threshold value.

The communication control method according to one aspect of the present invention as described further comprises the steps of: calculating an accumulated data rate, which is a proportion of uncompleted transmission number against data transmission request number calculated by the data transmission request number transmitted from the wireless base station device to the mobile terminals and the number of data which has been transmitted to the mobile terminal; detecting a traffic increase in the wireless medium through judging whether or not the calculated accumulated data rate is larger than a threshold value; and switching the communication control system from the distributed control function to the centralized control function when the accumulated data rate is larger than the threshold value.

The communication control method according to one aspect of the present invention as described further comprises the steps of: timing the time corresponding to a frame interval of data frame continuously present on the wireless medium; detecting a traffic increase in the wireless medium through judging whether or not the obtained time corresponding to the frame interval is smaller than a threshold value; and switching the communication control system from the distributed control function to the centralized control function when the time corresponding to the frame interval becomes smaller than the threshold value.

The communication control method according to one aspect of the present invention as described further comprises the step of: at the time of using the centralized control function, canceling a mobile terminal being in a state of power saving mode from authenticated mobile terminals which belong to the wireless base station device.

In the communication control method according to one aspect of the present invention as described, the distributed control function is DCF (Distributed Coordination Function) defined by IEEE802.11, the centralized control function is PCF (Point Coordination Function) defined by the IEEE802.11, and the wireless base station control device switches the communication control system from the DCF to the PCF due to an increase in traffic of a wireless LAN.

### BRIEF DESCRIPTION OF THE DRAWINGS

FIG. 1 is a block diagram showing the configuration of a high-order layer processing section of the present invention;

FIG. 2 is an illustration showing the configuration of a BSS of the present invention;

FIG. 3 is a block diagram showing the configuration of a wireless LAN card of the present invention;

FIG. 4 is an illustration showing the configuration of a MAC frame;

FIG. 5 is an illustration showing a beacon frame;

FIG. 6 is an illustration showing the configuration of CF Parameter Set in Frame Body;

FIG. 7 is an illustration showing an example of time distributions of CFP and CP;

FIG. 8 is a flowchart showing the operation procedure of an average data size check section of the present invention;

FIG. 9 is a flowchart showing the operation procedure of an accumulated data rate calculating section of the present invention;

FIG. 10 is a flowchart showing the operation procedure of a final CFP time calculating section of the present invention; and

FIG. 11 is a flowchart showing the operation procedures of a PCF request result calculating section and a PCF request processing section of the present invention.

### DETAILED DESCRIPTION OF THE PREFERRED EMBODIMENTS

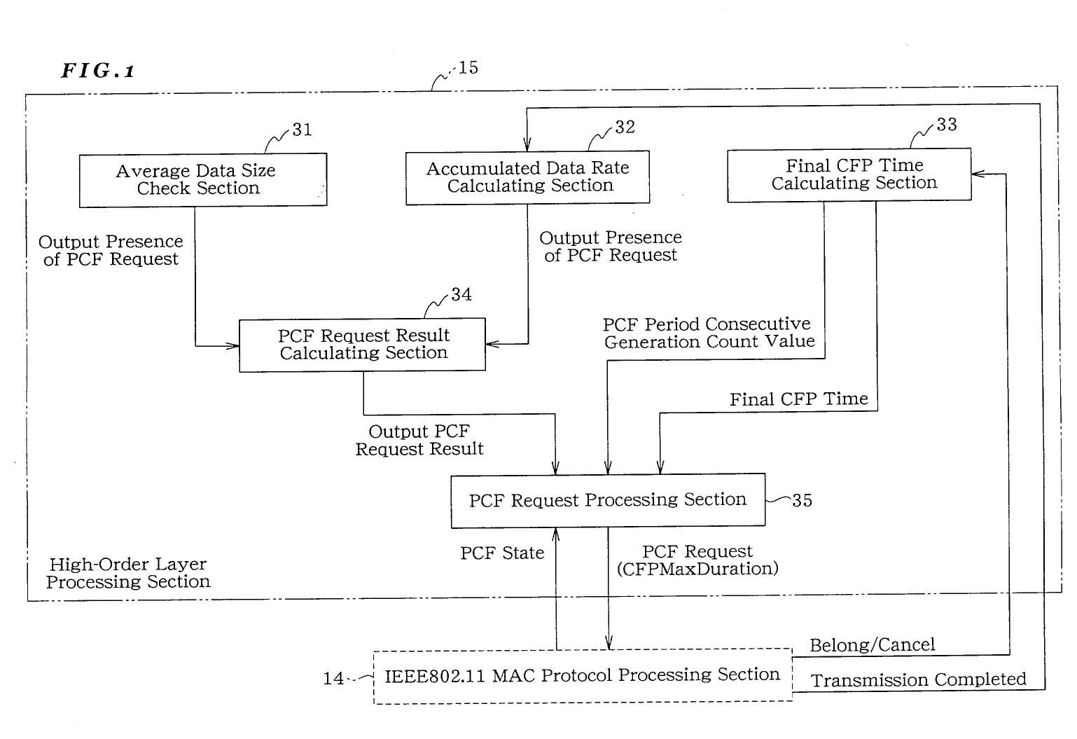

Now, an embodiment of a wireless base station device, a wireless communication system, and a communication control method of the present invention will be described in detail by referring to the accompanying drawings. FIG. 1 to FIG. 11 show the embodiment of the wireless base station device, the wireless communication system, and the communication control method of the present invention.

[Configuration]

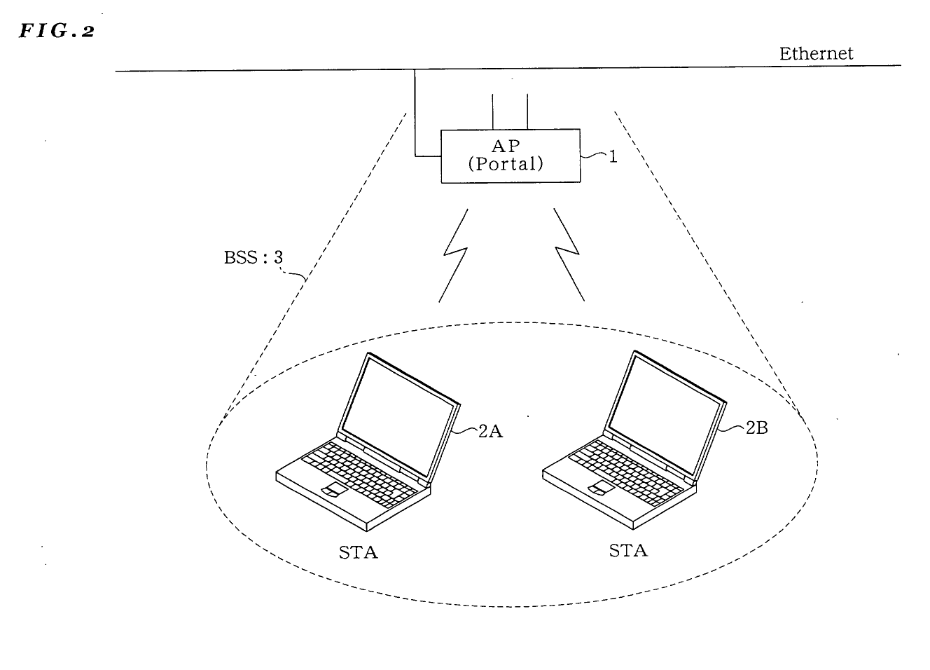

As shown in FIG. 2, the embodiment according to the present invention has a configuration of an infrastructure network comprising a wireless base station device (in the followings, it is referred to as AP since the discussion is concentrated on the function of access point of the wireless base station) 1 and a plurality of STA 2A and 2B. A minimum unit of a wireless LAN network formed as shown in FIG. 2 is referred to as a BSS (Basic Service Set) 3.

The AP (Access Point) 1 in the BSS 3 periodically performs broadcast transmission (transmission to unspecific number of receivers without designating the address where data is to be transmitted) of beacon frame, which is the information for retrieving each STA, containing information for each of the STAs (stations) 2A and 2B to synchronize with the AP 1. Then, each of the STAs 2A and 2B, after receiving the beacon frame, requests authentication to the AP 1 at the time of starting communication. After receiving authentication from the AP 1 and then completing processing for belonging to the AP 1, it becomes possible to perform exchange of data frame to/from the AP 1.

Further, a protocol conversion function for a LAN protocol other than IEEE802.11 is added to the AP 1 of the embodiment so that it can be connected to other networks such as Ethernet R.

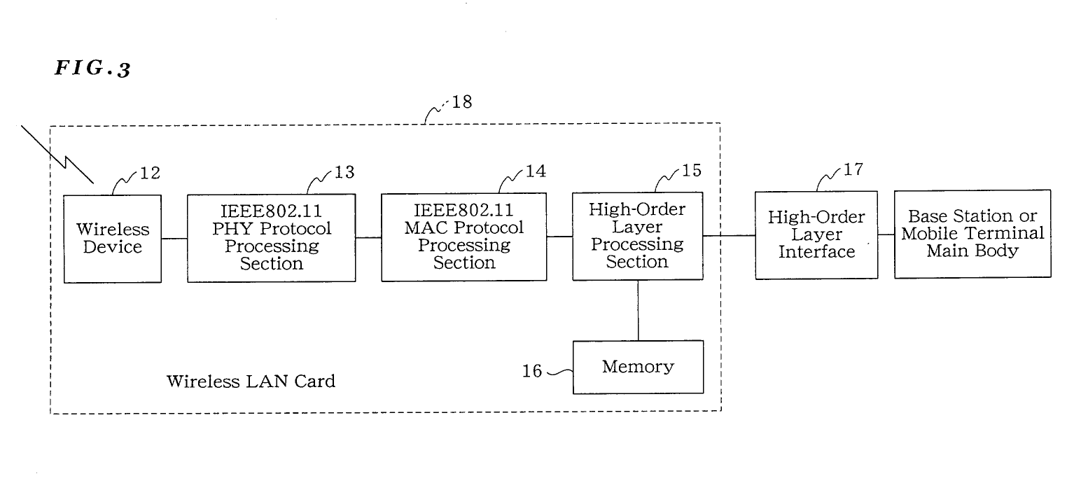

The AP 1 achieves protocol processing of TCP/IP and various applications via interface 17 between a wireless LAN card 18 and a high-order layer as shown in FIG. 3. Also, the STA 2 shown in FIG. 2 achieves protocol processing as in the case of the AP 1 by a mobile terminal such as a notebook-sized personal computer via the interface 17 between the wireless LAN card 18 and the high-order layer shown in FIG. 3.

The wireless LAN card 18 shown in FIG. 3 comprises a wireless device 12 for performing frame transmission/reception in a wireless section, an IEEE802.11 PHY protocol processing section 13 for performing modulation/demodulation processing, an IEEE802.11 MAC protocol processing section 14 for performing access control in a MAC (Medium Access Control) layer, and a high-order layer processing section 15 for achieving SME (Station Management Entity) processing such as authentication processing in the MAC layer by a built-in CPU and a memory 16.

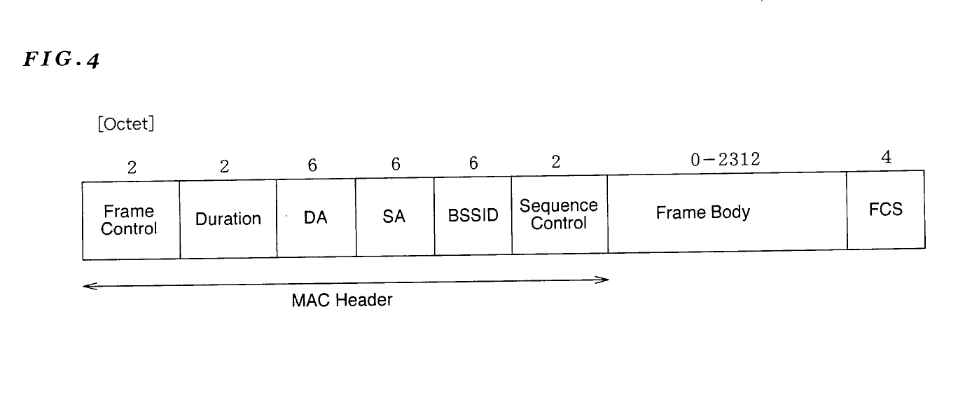

At the time of performing communication between the STA 2 and the AP 1, MAC frame according to a MAC frame format of IEEE802.11 shown in FIG. 4 is exchanged between the AP 1 and the STA 2. A MAC header which is the header of the MAC frame, as shown in FIG. 4, consists of Frame Control field denoting various frame types and control information, Duration field for defining the time for waiting transmission by supposing it as media BUSY when receiving data addressed to other receiver, DA (Destination Address) showing the frame transmission address, SA (Source Address) showing the address of the sender, BSSID denoting identifying information of the BSS, and Sequence Control field denoting the order of frame transmission.

At the time of frame transmission, in the IEEE802.11 MAC protocol processing section 14 shown in FIG. 3, first, transmission request frame transmitted from the high-order layer processing section 15 is formed into a capsule as Frame Body shown in FIG. 4. Then, the MAC header prepared based on the transmission request information is added before the Frame Body. Also, the result of CRC 32 (Cyclic Redundancy Code 32 bits) calculation on the MAC header and the Frame Body is added as FCS (Frame Check Sequence) after the Frame Body. Thereby, conversion to the MAC frame according to IEEE802.11 MAC protocol can be achieved.

Then, in the IEEE802.11 PHY protocol processing section 13 shown in FIG. 3, modulation processing is performed on the MAC frame and the frame is sent out onto space via the wireless device 12. Thereby, transmission processing is completed.

Also, at the time of receiving the frame, in the IEEE802.11 MAC protocol processing section 14 shown in FIG. 3, calculation of the CRC 32 is performed on the MAC frame received after performing demodulation processing in the IEEE802.11 PHY protocol processing section 13 through the wireless device 12. If the result of the CRC 32 calculation matches the FCS value in the received frame, analysis of the MAC header contents and processing on the received frame is performed in the IEEE802.11 MAC protocol processing section 14 and the Frame Body part in the frame is transmitted to the high-order layer processing section 15.

Functions of the AP in the infrastructure network are a distributed control function referred to as DCF which is essential and a centralized control function referred to as PCF which is optional.

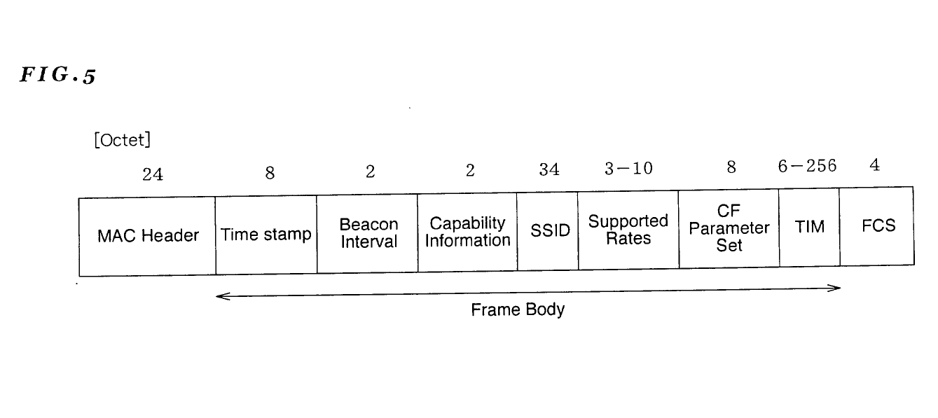

The frame transmission interval in the DCF is referred to as DIFS (Distributed Interframe Space) and the frame transmission interval in the PCF is referred to as SIFS (Short Interframe Space) which is defined to be a fixed time shorter than the DIFS. Further, the effective time in which the DCF operates, that is, the period in the time chart to be described later is referred to as CP (Contention Period) and the effective time in which the PCF operates is refereed to as CFP (Contention Free Period). The details are determined according to the information elements in the beacon frame shown in FIG. 5.

The beacon frame which is the information transmitted by the AP 1 consists of Time Stamp used in synchronizing processing of the AP 1 and the AP 2, Beacon Interval denoting the beacon transmission interval, Capability Information denoting the presence of the PCF function, SSID which is the identifier for network domain which can be designated by users at will, Supported Rate denoting information on the rate supported by the AP 1, CF Parameter Set which defines the parameter in regards to the PCF function, and TIM (Traffic Indication Map) denoting frame accumulation information in the AP.

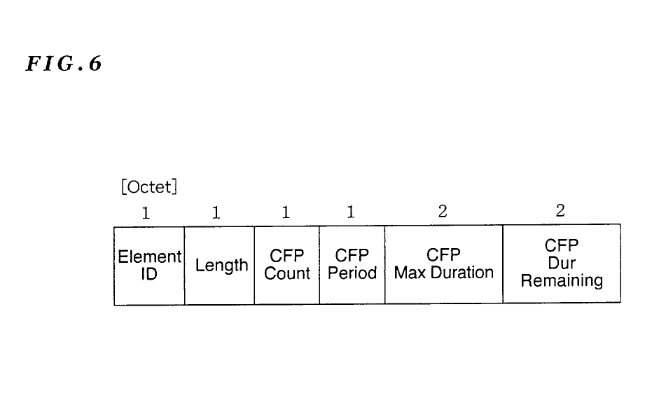

Also, the information elements in the CF Parameter Set consists of, as shown in FIG. 6, Element ID denoting the information elements, Length denoting the length of the information elements, CFP Count which is the time until the start of next CFP, CFP Period showing the cycle from the CFP start to the next CFP start by a form of a multiple number of the beacon transmission interval number referred to as DTIM (Delivery Traffic Indication Message) Period which is the information element in the TIM, CFP Max Duration denoting the effective time of the CFP, and CFP Dur Remaining denoting the remaining time of the CFP.

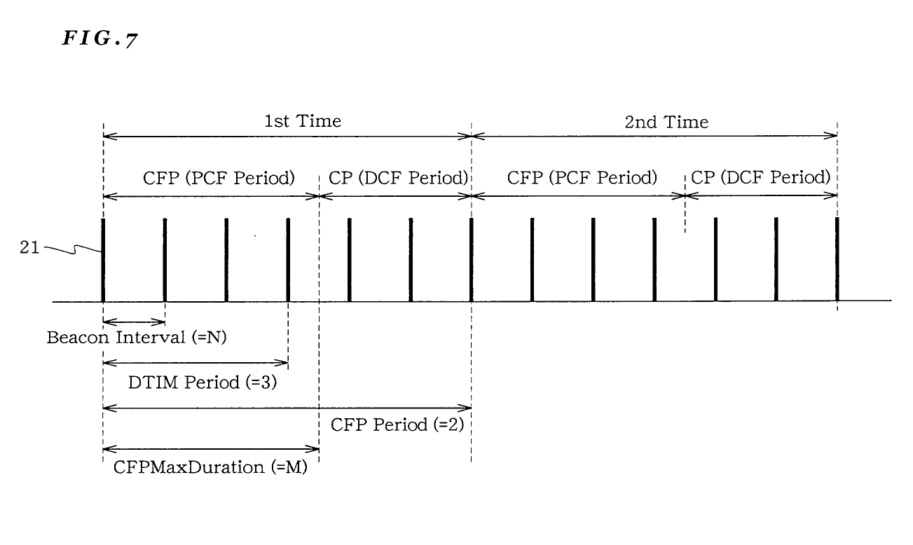

FIG. 7 shows the time distribution of the CFP and CP provided the Beacon Interval is N [TU:1 TU=1024×1 μs], the DTIM Period is 3, and the CFP Period is 2, CFP Max Duration is M [TU]. The STA 2 recognizes the specific time of the start, end and the like of the CFP based on the information elements in the beacon frame 21 and takes a communication form according to each section.

As for the set value of the CFP Max Duration, it is possible to set any values within the range between the maximum and minimum values calculated based on the definition of IEEE802.11. In the case where both the PCF and the DCF are used in the normal state, the PCF period and the DCF period are alternately repeated. In the case where there is no change in the information elements shown in FIG. 6, the PCF period and the DCF period are repeated by a fixed cycle as shown in FIG. 7.

Next, the configuration of the high-order layer processing section 15 will be described in detail by referring to FIG. 1. As shown in FIG. 1, the high-order layer processing section 15 comprises an average data size check section 31, an accumulated data rate calculating section 32, a final CFP time calculating section 33, a PCF request result calculating section 34, and a PCF request processing section 35.

The average data size check section 31 calculates the mean value of the sizes of data received from the STA 2 and data transmitted to the STA 2 by every given time and outputs the presence of PCF request to the PCF request result calculating section 34 based on the calculated mean value of the data size. The average data size check section 31 detects the size of the Frame Body in the MAC frame shown in FIG. 4 and calculates the mean value.

The accumulated data rate calculating section 32 calculates, by every given time, the accumulated data rate which is the proportion of uncompleted transmission number against the transmission request number obtained from the transmission request number transferred from the high-order device of the wireless LAN card 18 shown in FIG. 3 and the completed transmission number which is the number of the completed data transmission to the STA 2, and transmits the presence of the PCF request to the PCF request result calculating section 34 based on the calculated accumulated data rate.

The final CFP time calculating section 33, first, calculates the CFP time according to the number of STA 2 belonging to the AP 1. Then, it outputs, to the PCF request processing section 35, the PCF period consecutive generation count for generating the PCF period for the calculated PCF time and the final CFP time as a set element for the CFP Max Duration which is the parameter for the PCF request.

The PCF request result calculating section 34 judges when to start the CFP based on the PCF request outputted from the average data size check section 31 or the accumulated data rate calculating section 32, and outputs the judgment result to the PCF request processing section 35. In the embodiment, the PCF request result calculating section 34 judges the start of the PCF when the PCF start request is outputted from either the average data size check section 31 or the accumulated data rate calculating section 32. However, the PCF request result calculating section 34 may judge the start of the PCF when the PCF start request is outputted from both the average data size check section 31 and the accumulated data rate calculating section 32.

The PCF request processing section 35, when recognizing the non-PCF state based on the PCF state report information transmitted from the IEEE802.11 MAC protocol processing section 14 and receiving a message that there is a PCF request from the PCF request result calculating section 34, transmits the PCF request and the set value for the CFP MAX Duration to the IEEE802.11 MAC protocol processing section 14 by referring to the PCF period consecutive generation count, which is the output result of the final CFP time calculating section 33, and the final CFP time.

In the embodiment with the above-described configuration, the AP 1 which operates in the DCF as a normal state analyzes the own communication state and performs the switching flexibly from the DCF to the PCF according to the analyzed result. As the analyzing method of the communication state of the AP 1, first, the mean value of the transmitted/received data sizes in a certain time is calculated in the average data size check section 31 shown in FIG. 1 or data accumulation rate is calculated in the accumulated data rate calculating section 32. Then, an increase in the traffic of the wireless LAN is detected by comparing each of the calculated result to the threshold values set at will, and a request for switching the DCF to the PCF is outputted. When performing transmission/reception of data frame, the larger the data size is, the longer the time of occupying the wireless medium becomes. Further, high data accumulated rate of the AP 1 means the presence of a large number of STAs within the BSS 3. Therefore, the occupied rate of the wireless medium by a third party becomes high.

Thus, in consideration of the output results of both in the PCF request result calculating section 34, the final judgment for switching the AP operation from the DCF state to the PCF state is achieved in the PCF request processing section 35 and a start request of the PCF is outputted to the IEEE802.11 MAC protocol processing section 14.

Furthermore, in the embodiment, when switching the communication control system from the DCF to the PCF, the CFP time in which the PCF effectively operates is calculated based on the number of the STA 2 belonging to the wireless base station device. When the number of the STA 2 belonging to the AP 1 is small, the PCF repeats polling a plurality of times for the same STA 2 in one period in which the PCF is effective. Also, when the number of the STA 2 is large, polling cannot be performed to all the STA 2.

Therefore, in the embodiment, the set value for the CFP Max Duration showing the PCF period, which is necessary as a parameter when the AP 1 starts the PCF state, is to be calculate when necessary based on the number of the STA 2 as the terminals belonging to the AP 1. Thereby, all the STA 2 receives a transmission rights distributed by the AP 1 so as to be given equal transmission opportunity. At this time, if distributing of the transmission rights to all the STA 2 cannot be achieved by one PCF period, switching request to the PCF is performed forcibly in the PCF request processing section 35 even if there is no PCF request in the communication state analyzed result in the PCF request result calculating section 34 after the first PCF period.

[Description of Operation]

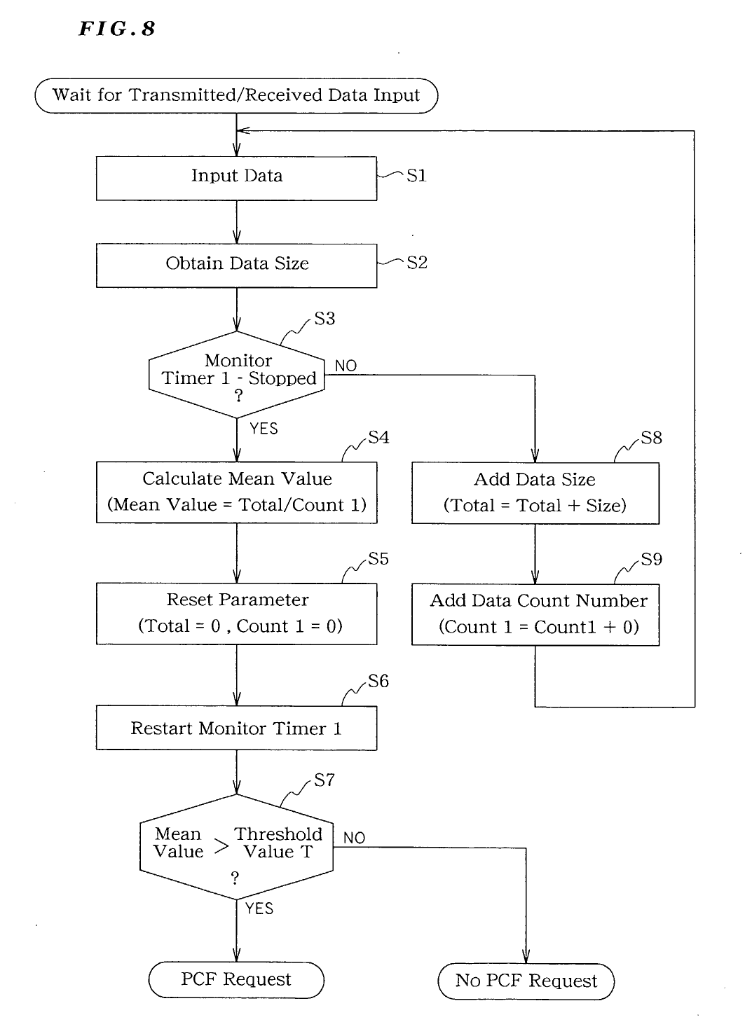

Next, the procedure of the specific processing for achieving the above-described object will be described by referring to flowcharts shown in FIG. 8 to FIG. 11.

First, the operation procedure of the average data size check section 31 will be described by referring to a flowchart shown in FIG. 8. The average data size check section 31 outputs the presence of the PCF request to the PCF request result calculating section 34 based on the mean value of the sizes of received/transmitted data in the AP 1 by every given time.

The average data size check section 31 performs data input processing (step S1) every time there is transmitted/received data corresponding to the Frame Body shown in FIG. 4, which is exchanged between the high-order layer interface 17 and the high-order layer processing section 15 shown in FIG. 3. Then, the average data size check section 31 obtains the data size (size) and keeps the value (step S2). Total, the added value of the data size, and the counted value Count 1, which is the number of data, are set to be 0 at the initial state.

Subsequently, the average data size check section 31 checks the operation state of a started monitor timer 1 (step S3) which is provided beforehand in the outside of the average data size check section 31. When the monitor timer 1 is in operation (step S3/NO), it performs adding of data size (step S8, Total=Total+size) and adding of data number count (step S9, Count 1=count 1+1). It returns to the step S1 at a next input processing of transmitted/received data.

When the monitor timer 1 is not in operation (step S3/YES), the mean value of the data size is calculated (step S4, mean value=Total/Count 1) when the monitoring time set at will by the monitor timer 1 runs out. Also, the parameters for adding data size and for counting the number of data are reset (step S5) and the monitor timer 1 is restarted (step S6).

Then, a threshold value T of a PCF request judging, which is set beforehand by every AP, and the mean value calculated in the step S4 are compared (step S7). When the mean value of the transmitted/received data sizes is larger than the threshold value T (step S7/YES), the average data size check section 31 outputs information to the PCF request result calculating section 34 showing that there is a PCF request and, outputs information indicating there is no PCF request in other cases (step S7/NO).

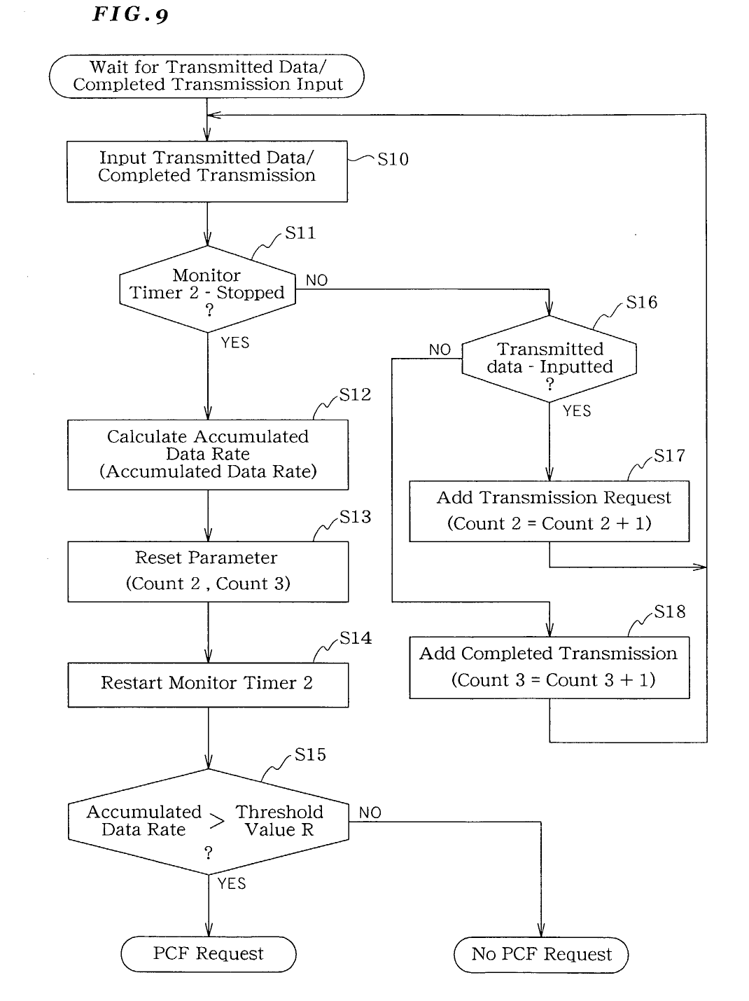

Next, the operation procedure of the accumulated data rate calculating section 32 will be described by referring to a flowchart shown in FIG. 9. The accumulated data rate calculating section 32 shown in FIG. 1 calculates, by every given time, the accumulated data rate which is the proportion of the number of uncompleted transmission against the transmission request calculated from the transmission request number (Count 2) and the number of the completed transmission (Count 3) of the AP 1, and outputs the presence of the PCF request based on the calculated accumulated data rate.

The accumulated data rate calculating section 32 detects the input (step S10) every time there is transmission data corresponding to the Frame Body shown in FIG. 4, which is inputted from high-order layer interface 17 to the high-order layer processing section 15 shown in FIG. 3, or there is transmission completed message transmitted from the IEEE802.11 MAC protocol processing section 14 shown in FIG. 1.

Subsequently, the accumulated data rate calculating section 32 checks the operation state of a started monitor timer 2 (step S11) which is provided beforehand in the outside of the accumulated data rate calculating section 32. When the monitor timer 2 is in operation (step S11/NO), it checks the inputted content (step S16). If the inputted content is transmission data (step S16/YES), it performs adding of transmission data count (step S17, Count 2=Count 2+1). If the inputted content is transmission completed message, it performs adding of data number count (step S18, Count 3=count 3+1). It returns to the step S10 at a next data transmission or input processing of the transmission completed massage. The added values, the Count 2 and Count 3, are set to be 0 at the initial state, respectively.

In the step S11, when the monitor timer 2 is not in operation (step S11/YES), the accumulated data rate, which is calculated from the proportion of the count of the uncompleted transmission against the transmission request count, is calculated (step S12, accumulated data rate=(Count 2−Count 3)/Count 2) when the monitoring time set at will by the monitor timer 2 runs out. Also, the parameters for the transmission request account and the completed transmission account are reset (step S13) and the monitor timer 2 is restarted (step S14).

Then, the accumulated data rate calculated in the step S12 and a threshold value R of the transmission data accumulated rate set beforehand by every AP are compared (step S15). When the transmission data accumulated rate is larger than the threshold value R (step S15/YES), the accumulated data rate calculating section 32 outputs information to the PCF request result calculating section 34 showing that there is a PCF request, and outputs information indicating there is no PCF request in other cases (step S15/NO).

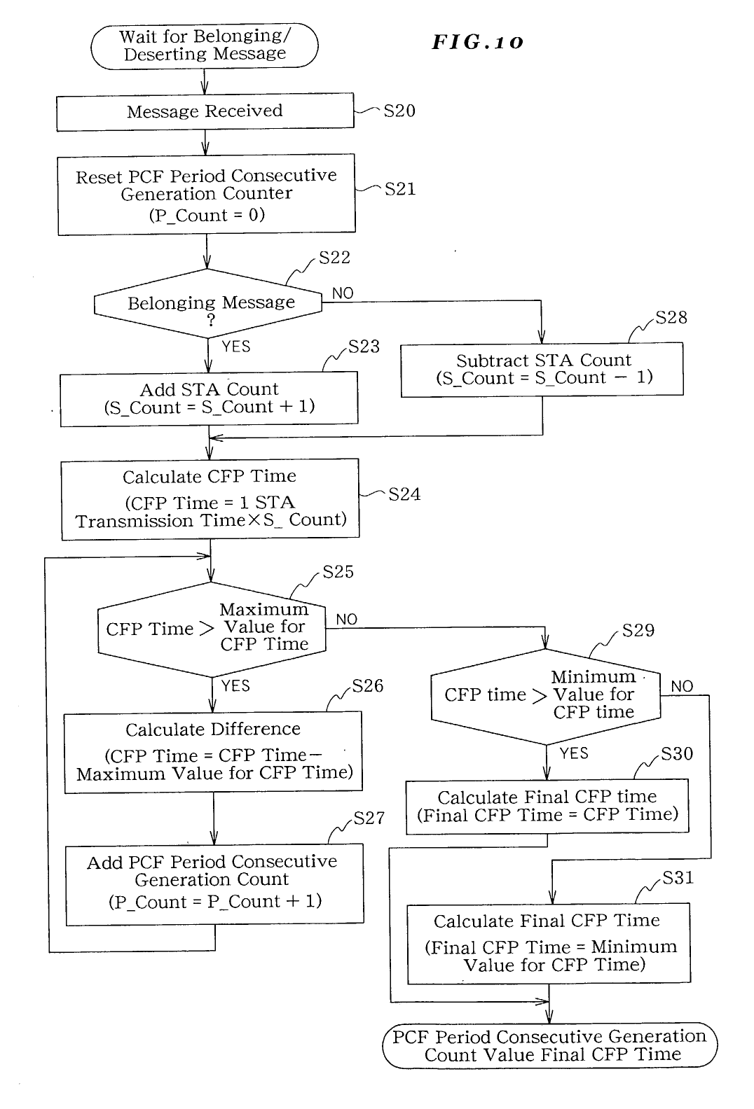

Next, the operation procedure of the final CFP time calculating section 33 will be described by referring to a flowchart shown in FIG. 10. The final CFP time calculating section 33 calculates the CFP time according to the number of the STA 2 belonging to the AP 1, and transmits, to the PCF request processing section 35, the PCF period consecutive generation count for generating the PCF period for the calculated CFP time and the final CFP time as a set element for the CFP Max Duration which is the parameter for the PCF request.

The final CFP time calculating section 33 recognizes belonging of the STA 2 to the AP 1 from the IEEE802.11 MAC protocol processing section 14 shown in FIG. 1 or recognizes the inputted deserting message of the STA 2 for the AP 1 (step S20), and resets the PCF period consecutive generation count (step S21, P_{Count=}0).

Subsequently, the final CFP time calculating section 33 judges the content inputted from the IEEE802.11 MAC protocol processing section 14 shown in FIG. 1 (step S22). If the inputted content is a belonging message (step S22/YES), STA counts are added (Step S23, S_Count=S Count+1). If the inputted content is a deserting message (step S22/NO), the STA counts are subtracted (Step S28, S_Count=S_Count−1). S_Count, the STA count value, is set to be 0 at the initial state and the number of the belonging STAs in the state where the power is supplied and the like is substituted as the count value.

Then, the CFP time corresponding to the CFP Max Duration value is calculated (step S24) by multiplying the number of the STA (S_Count) calculated in the step S23 or the step S28 by the transmission time (1 STA transmission time) distributed to one STA which is defined beforehand as the total of time required for transmitting polling frame and data frame from the AP 1 to a given STA 2 and time required for transmitting data frame from the given STA to the AP 1.

In the CFP Max duration value, there are the maximum and minimum values defined by the IEEE802.11. Thus, the CFP time calculated in the step S24 and the pre-set CFP maximum value which is calculated based on the definition of the IEEE802.11 are compared (step S25). If the calculated result of the CFP time is larger than the maximum value defined beforehand, (step S25/YES), the difference is calculated (step S26, CFP time−CFP time maximum value). The balance is set as a new CFP time and adds the PCF period consecutive generation count (step S27, P_Count=P_Count+1). Then, the CFP time obtained in the step S26 as the balance and the CFP time maximum value are compared (step S25). The same processing is repeated (step S25 to step S27) until when it is judged the CFP time maximum value is larger.

When it is judged that the CFP time maximum value is larger than the CFP time calculated in the step S24 or the CFP time calculated in the step S27 (step 25/NO), the pre-set CFP minimum value calculated according to the definition of the IEEE802.11 and the CFP time are compared (step S29).

If the CFP time is larger than the CFP time minimum value (step S29/YES), the CFP time is outputted to the PCF request processing section 35 as the final CFP time (step S30). If the CFP time minimum value is larger than the CFP time (step S29/NO), the CFP time minimum value is outputted as the final CFP time (step S31). At this time, the final CFP time calculating section 33 also outputs the PCF period consecutive generation count value (P_Count) to the PCF request processing section 35.

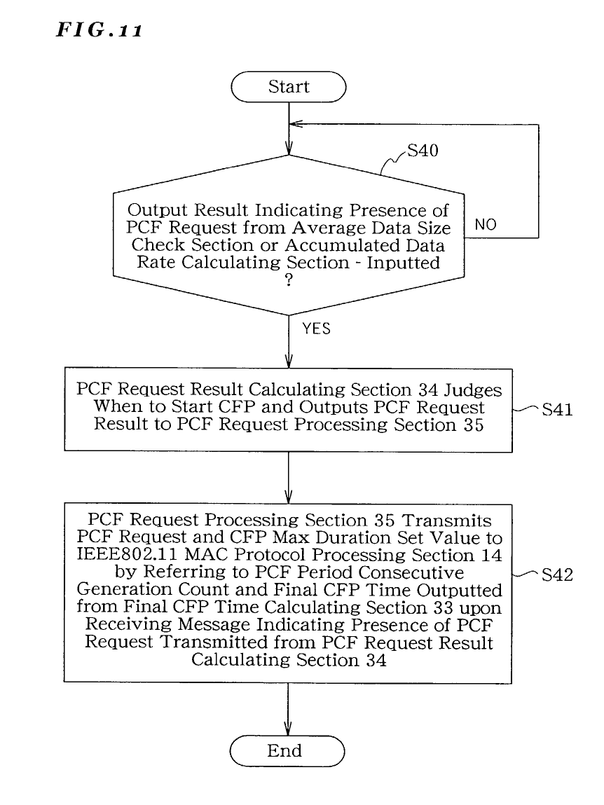

Next, the operation procedures of the PCF request calculating section 34 and the PCF request processing section 35 will be described by referring to a flowchart shown in FIG. 11.

The PCF request result calculating section 34 shown in FIG. 1, when the result showing there is a PCF request is outputted from the average data size check section 31 or the accumulated data rate calculating section 32 (step S40/YES), judges when to start the CFP on the basis of the outputted result, and outputs the PCF request result to the PCF request processing section 35 (step S41).

The PCF request processing section 35, when recognizing the non-PCF state from the PCF state message transmitted from the IEEE802.11 MAC protocol processing section 14 and receiving a message showing there is a PCF request from the PCF request result calculating section 34, transmits a PCF request and the CFP Max Duration setting (step S42) by referring to the PCF period consecutive generation count and the final CFP time which are the output of the final CFP time calculating section 33. However, only when the value of the PCF period consecutive generation count is a positive number except for 0, the PCF request processing section 35 continues the transmission of PCF request for the number of the PCF period consecutive generation count to the IEEE802.11 MAC protocol processing section 14 regardless of the result outputted from the PCF request result calculating section 34 in the DCF period after completing the PCF period. In this case, the CFP time maximum value which is calculated and set beforehand based on the definition of the IEEE802.11 is distributed to the set value for the CFP Max Duration from the first PCF request to the PCF requests for the number of the PCF period consecutive generation count. The final CFP time which is the output of the final CFP time calculating section 33 is set only for the set value for the CFP Max Duration at the time of last PCF request.

As described, in the embodiment, the AP 1 which operates by the DCF in a normal state analyzes the own communication state and performs the switching flexibly from the DCF to the PCF according to the analyzed result. In the IEEE802.11 wireless LAN protocol which defines the DCF to be essential, the DCF is used as a basic function giving equal transmission rights to AP 1 and STA 2 when, for example, there is less transmission requests from the STA 2. Thus, it is desirable to operate the PCF when necessary but not as a fixed function used at all time. As for the PCF, there is no transmission competition generated in the BSS within the CFP time in which the PCF effectively operates so that the interval of data frame generated continuously on a wireless medium can be made as the shortest SIFS time among the values defined by the IEEE802.11. Accordingly, in regards to the occupying time of the medium, the PCF can exchange the frame more effectively compared to the DCF. However, in the PCF, transmission rights are distributed to all the STAs belonging within the BSS so that inquiries are to be made even to STAs in no need for opportunities for transmitting/receiving data frame by polling. Thereby, extra time is to be wasted. Thus, it is necessary to switch from the DCF to the PCF by detecting the traffic state of the wireless medium.

At the time of performing transmission/reception of data frame, the data size is, the longer the time of occupying the medium becomes. Thereby, when the state where the mean value of the data size exceeds a certain value continues in the average data size check section 31 shown in FIG. 31, a PCF request is retransmitted in the DCF period after completing a given PCF period. Thus, by using both the DCF and PCF, the occupying time of the wireless medium can be effectively utilized compared to the case of using only the DCF as a communication form with possibility of collisions, which requires transmission intervals for the RBO time and the DIFS time every time.

High data accumulated rate of the AP 1 means the presence of a large number of STAs within the BSS 3. Therefore, the occupied rate of the wireless medium by a third party becomes high. Thus, for the AP 1, success rate of obtaining the transmission right using random numbers by RBO in the DCF becomes low. Therefore, there are less opportunities to be able to transmit data and, at the same time, increases the possibility of exhausting the buffer on the wireless base station side. Thus, the data accumulated rate is detected in the accumulated data rate calculating section 32 shown in FIG. 1 and, when the threshold value exceeds the data accumulated rate, the DCF is switched to the PCF. Thereby, equal communication opportunities can be given to all the terminals in the BSS and, at the same time, exhaustion of the buffer due to the continuous accumulation of transmitted data in the wireless base station can be avoided.

Further, when the set value for the CFP Max Duration defining the CFP time is to be a fixed value, the AP 1 performs polling for distributing the transmission rights regardless of the number of the STA 2 belonging to the AP 1. Thus, especially when there is a small number of the STA belonging to the AP 1, a plurality of numbers of polling is be performed for the same STA 2 in one period in which the PCF is effective. Hence, it is less necessary to distribute the transmission rights using the PCF in the case where there is a small number of STA belonging to the AP 1. Accordingly, the time in which the PCF becomes effective may be the time sufficient to give the equal transmission rights to all the STA belonging to the AP 1. Thus, in the case where the set value for the CFP Max Duration in the given PCF period (effective time in which the PCF operates) is calculated based on the number of the belonged STA and if distribution of the transmission rights for all the STA 2 cannot be performed in one PCF period, another PCF period is forcibly provided for performing polling to all the STA 2. Thereby, the PCF period is effectively utilized without waste.

### MODIFICATION EXAMPLE 1

In the above-described embodiment, the final CFP calculating section 33 of the high-order layer processing section 15 recognizes the number of the STA 2 belonging to the AP 1 based on the belonging or deserting message of the STA 2 transmitted from the IEEE802.11 MAC protocol processing section 14. It is used as the parameter for calculating the CFP Max Duration.

However, there is a function in the STA 2 for turning into a power saving mode at a given timing and cutting the communication. Thus, there may be presented a method in which the power saving state of the STA 2 is added as an element for calculating the CFP Max Duration and calculating the CFP Max Duration in consideration of the number of the STA 2 which is substantially communicable with the AP 1. Specifically, the STA 2 turning into the power saving mode transmits the MAC frame to the AP 1 by attaching a flag to the power management bit present in the Frame Control field in the MAC frame shown in FIG. 4. The AP 1 recognizes that the STA 2 has turned into the power saving mode upon receiving the MAC frame with flag attached to its power management bit. Then, the final CFP calculating section 33 calculates the belonging number except for the STA 2 turned into the power saving mode when calculating the number of the belonging STA 2. Thereby, the CFP Max Duration can be calculated in consideration of the number of the STA 2 substantially communicable with the AP 1.

### MODIFICATION EXAMPLE 2

Further, in the above-described embodiment, the average data size of the frame data and the accumulated data rate are used as information for analyzing the communication state of the AP 1. However, there may be a method in which appropriateness of using the PCF as a communication method, which transmits the frame in the SIFS interval, is judged and the PCF request processing section 35 outputs the PCF request when the time becomes a certain value or less, since the state of the load on traffic can be detected by monitoring the time corresponding to the frame interval of the frame data continuously present on the wireless medium. In this case, the PCF request result calculating section 34 outputs a message indicating there is a PCF request in the case where it is judged that either one, two or all of judging materials including the average data size, accumulated data rate, data frame, or the frame interval indicates an increase in the load on the traffic.

The embodiment described above is a preferable embodiment of the present invention. However, it is not limited to this but various modifications are possible within the spirit and broad scope of the appended claims.

As evident from the description presented above, in the present invention, transmission/reception of data between the wireless base station device and the mobile terminals are controlled by polling using a centralized control function when the state where the mean value of the data size exceeds a certain value continues since, the larger the data size is, the longer the time of occupying the medium becomes at the time of performing transmission/reception of data frame. Hence, the wireless base station device and the mobile terminals are to have the equal transmission rights thereby generating possibilities of collision. Thus, it becomes possible to more effectively utilize the occupied time of the wireless medium compared to the case using only the distributed control function, which requires a longer waiting time than the centralized control function as a communication form.

High data accumulated rate means the presence of a large number of belonging mobile terminals. Therefore, the occupied rate of the wireless medium by a third party becomes high. Thus, for the wireless base station device, success rate of obtaining the transmission right becomes low, which causes a problem of exhausting the buffer on the wireless base station side. Thus, the data accumulated rate of the wireless base station device is detected and, when the threshold value exceeds the data accumulated rate, the communication control system is switched from the distributed control function to the centralized control function. Thereby, equal communication opportunities can be given to all the terminals belonging to the wireless base station device and, at the same time, exhausting of the buffer due to the continuous accumulation of transmitted data in the wireless base station can be avoided.

Further, the state of the load on traffic can be detected by monitoring the time corresponding to the frame interval of the frame continuously present on the wireless medium. Thus, when the time becomes a certain value or less, the control system may be switched to the one using the centralized control function. Thereby, compared to the case of using only the distributed control function, the occupied time of the wireless medium can be more effectively utilized.

Further, when the effective time for the centralized control function is fixed, the wireless base station device is to perform polling for distributing the transmission rights regardless of the number of the mobile terminals belonging thereto. Thus, especially when there is a small number of the mobile terminals belonging to the wireless base station device, a plurality of numbers of polling is to be performed for the same mobile terminal in the effective time for the centralized control function. Thus, the effective time for the centralized control function is calculated based on the number of the belonging mobile terminals to provide the sufficient time to give the equal transmission rights to all the belonging mobile terminals. Thereby, the effective period for the centralized control function can be utilized without waste as much as possible.

Moreover, there is a function in the mobile terminals for turning into a power saving mode at a given timing and cutting the communication. Thus, the effective period for the centralized control function can be more effectively utilized without waste by calculating the effective time for the centralized control function which is calculated based on the number of the belonging mobile terminals in consideration of the number of the mobile terminal substantially communicable with the wireless base station device.

The invention may be embodied in other specific forms without departing from the spirit or essential characteristic thereof. The present embodiments is therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-397953 (Filed on Dec. 27, 2001) including specification, claims, drawings and summary are incorporated herein by reference in its entirety.

What is claimed is:

1. A wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the point coordination function operates, wherein
the communication control system is switched from the distributed control function to the centralized control function when a state where the average data size of data frame transmitted/received to/from the mobile terminal exceeds a certain value continues for a prescribed time.

2. A wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates, wherein
the communication control system is switched from the distributed control function to the centralized control function when the accumulated data rate, which is a proportion of uncompleted transmission number against data transmission request number calculated by the data transmission request number transmitted from the wireless base station device to the mobile terminal and the number of data which has been transmitted to the mobile terminal, is higher than a prescribed threshold value.

3. A wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates, wherein
the communication control system is switched from the distributed control function to the centralized control function when time corresponding to a frame interval is detected to be a prescribed threshold value or less by monitoring the time corresponding to the frame interval of data frame continuously present on the wireless medium.

4. A wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates, wherein
at the time of switching the communication control function from the distributed control function to the centralized control function due to an increase in a traffic of a wireless medium, when the transmission rights cannot be distributed to all the mobile terminals belonging to the wireless base station device within an effective time in which the centralized control function is allowed to operate, communication control is to be achieved also after the effective time by providing another effective time in which the centralized control function operates.

5. A wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium (traffic of communication quantity), controlling transmission/reception of data to/from the mobile terminal by a communication control system based on a centralized control function system through polling, which requires a second waiting time as a transmission interval of the data frame that is shorter than the first waiting time, through providing an effective time during which the function operates, wherein
at the time of switching the communication control function from the distributed control function to the centralized control function due to an increase in traffic of a wireless medium, the total time required for performing transmission/reception of data to/from all the mobile terminals belonging to the wireless base station device is calculated and communication control is performed by polling having the calculated time as the effective time for centralized control function.

6. The wireless base station device as claimed in claim 4, comprising an average data size calculating unit for calculating the mean value of transmission/reception data size within a certain time as a unit for detecting a traffic increase in the wireless medium, wherein
the communication control system is switched from the distributed control function to the centralized control function when the average data size calculated by the average data size calculating unit is larger than a threshold value.

7. The wireless base station device as claimed in claim 4, comprising, as a unit for detecting a traffic increase in the wireless medium, an accumulated data rate calculating unit for calculating an accumulated data rate, which is a proportion of uncompleted transmission number against data transmission request number calculated by the data transmission request number transmitted from the wireless base station device to the mobile terminal and the number of data which has been transmitted to the mobile terminal, wherein
the communication control system is switched from the distributed control function to the centralized control function when the accumulated data rate calculated by the accumulated data rate calculating unit is larger than a threshold value.

8. The wireless base station device as claimed in claim 4, comprising, as a unit for detecting a traffic increase in the wireless medium, a timing unit for timing the time corresponding to a frame interval of data frame continuously present on the wireless medium, wherein
the communication control system is switched from the distributed control function to the centralized control function when the time corresponding to the frame interval becomes a threshold value or less.

9. The wireless base station device as claimed in claim 4, wherein, at the time of using the centralized control function, a mobile terminal in a state of power saving mode is canceled from authenticated mobile terminals which belong to the wireless base station device.

10. The wireless base station device as claimed in claim 1, wherein: the distributed control function is DCF (Distributed Coordination Function) defined by IEEE802.11; the centralized control function is PCF (Point Coordination Function) defined by the IEEE802.11; and the communication control system is switched from the DCF to the PCF due to an increase in traffic of a wireless LAN.

11. A wireless communication system comprising a mobile terminal and a wireless base station device performing transmission/reception of data to/from the mobile terminal via a wireless medium, wherein
the wireless base station device has the equal transmission right with the mobile terminal and controls transmission/reception of data to/from the mobile terminal by, as a control system in a normal state, a communication control system based on a distributed control function which requires a first waiting time as a transmission interval of a data frame which is a unit of data to be transmitted, while controlling transmission/reception of data to/from the mobile terminal by a communication control system based on a centralized control function through polling which requires a second waiting time as a transmission interval of the data frame that is shorter than the first waiting time, through providing an effective time during which the function operates by detecting a traffic increase in the wireless medium when a state where the average data size of data frame transmitted/received to/from the mobile terminal exceeds a certain value continues for a prescribed time.

12. A wireless communication system comprising a mobile terminal and a wireless base station device performing transmission/reception of data to/from the mobile terminals via a wireless medium, wherein
the wireless base station device has the equal transmission right with the mobile terminal and controls transmission/reception of data to/from the mobile terminal by, as a control system in a normal state, a communication control system based on a distributed control function which requires a first waiting time as a transmission interval of a data frame which is a unit of data to be transmitted, while controlling transmission/reception of data to/from the mobile terminal by a communication control system based on a centralized control function through polling which requires a second waiting time as a transmission interval of the data frame that is shorter than the first waiting time, through providing an effective time during which the function operates by detecting a traffic increase in the wireless medium when the accumulated data rate, which is a proportion of uncompleted transmission number against data transmission request number calculated by the data transmission request number transmitted from the wireless base station device to the mobile terminal and the number of data which has been transmitted to the mobile terminal, is higher than a prescribed threshold value.

13. A wireless communication system comprising a mobile terminal and a wireless base station device performing transmission/reception of data to/from the mobile terminals via a wireless medium, wherein
the wireless base station device has the equal transmission right with the mobile terminal and controls transmission/reception of data to/from the mobile terminal by, as a control system in a normal state, a communication control system based on a distributed control function which requires a first waiting time as a transmission interval of a data frame which is a unit of data to be transmitted, while controlling transmission/reception of data to/from the mobile terminal by a communication control system based on a centralized control function through polling which requires a second waiting time as a transmission interval of the data frame that is shorter than the first waiting time, through providing an effective time during which the function operates by detecting a traffic increase in the wireless medium when time corresponding to a frame interval is detected to be a prescribed threshold value or less by monitoring the time corresponding to the frame interval of data frame continuously present on the wireless medium.

14. A wireless communication system comprising a mobile terminal and a wireless base station device performing transmission/reception of data to/from the mobile terminal via a wireless medium, wherein:
the wireless base station device has the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates; and
at the time of switching the communication control function from the distributed control function to the centralized control function due to an increase in a traffic of a wireless medium, when the transmission rights cannot be distributed to all the mobile terminals belonging to the wireless base station device within an effective time in which the centralized control function is allowed to operate, communication control is to be achieved also after the effective time by providing another effective time in which the centralized control function operates.

15. A wireless communication system comprising a mobile terminal and a wireless base station device performing transmission/reception of data to/from the mobile terminal via a wireless medium, wherein:
the wireless base station device has the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates; and
at the time of switching the communication control function from the distributed control function to the centralized control function due to an increase in a traffic of a wireless medium, the total time required for performing transmission/reception of data to/from all the mobile terminals belonging to the wireless base station device is calculated and communication control is performed by polling having the calculated time as the effective time for centralized control function.

16. The wireless communication system as claimed in claim 14, wherein: the wireless base station comprises an average data size calculating unit for calculating the mean value of transmission/reception data size within a certain time as a unit for detecting a traffic increase in the wireless medium, and
the communication control system is switched from the distributed control function to the centralized control function when the average data size calculated by the average data size calculating unit is larger than a threshold value.

17. The wireless communication system as claimed in claim 14, wherein: the wireless base station device comprises, as a unit for detecting a traffic increase in the wireless medium, the accumulated data rate calculating unit for calculating an accumulated data rate, which is a proportion of uncompleted transmission number against data transmission request number calculated by the data transmission request number transmitted from the wireless base station device to the mobile terminal and the number of data which has been transmitted to the mobile terminal; and
the communication control system is switched from the distributed control function to the centralized control function when the accumulated data rate calculated by the accumulated data rate calculating unit is larger than a threshold value.

18. The wireless communication system as claimed in claim 14, wherein: the wireless base station device comprises, as a unit for detecting a traffic increase in the wireless medium, a timing unit for timing the time corresponding to a frame interval of data frame continuously present on the wireless medium; and
the communication control system is switched from the distributed control function to the centralized control function when the time corresponding to the frame interval becomes a threshold value or less.

19. The wireless communication system as claimed in claim 14, wherein, at the time of using the centralized control function, the wireless base station device cancels a mobile terminal in a state of power saving mode from authenticated mobile terminals which belong to the wireless base station device.

20. The wireless communication system as claimed in claim 11, wherein: the distributed control function is DCF (Distributed Coordination Function) defined by IEEE802.11; the centralized control function is PCF (Point Coordination Function) defined by the IEEE802.11; and the wireless base station device switches the communication control system from the DCF to the PCF due to an increase in a traffic of a wireless LAN.

21. A communication control method used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates, comprising the step of: switching the communication control system from the distributed control function to the centralized control function when a state where the average data size of data frame transmitted/received to/from the mobile terminal exceeds a constant value continues for a prescribed time.

22. A communication control method used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame shorter than the first waiting time, through providing an effective time during which the function operates, comprising the step of: switching the communication control system from the distributed control function to the centralized control function when the accumulated data rate, which is a proportion of uncompleted transmission number against data transmission request number calculated by the data transmission request number transmitted from the wireless base station device to the mobile terminal and the number of data which has been transmitted to the mobile terminal, is higher than a prescribed threshold value.

23. A communication control method used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates, comprising the step of: switching the communication control system from the distributed control function to the centralized control function when time corresponding to a frame interval is detected to be a prescribed threshold value or less by monitoring the time corresponding to the frame interval of data frame continuously present on the wireless medium.

24. A communication control method used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates, comprising the step of: providing another effective time in which the centralized control function operates for achieving communication control when the transmission rights cannot be distributed to all the mobile terminals belonging to the wireless base station device within an effective time in which the centralized control function is allowed to operate, when switching the communication control function from the distributed control function to the centralized control function due to an increase in traffic of a wireless medium.

25. A communication control method used in a wireless base station device having the equal transmission right with a mobile terminal for controlling transmission/reception of data to/from the mobile terminal by, as a control system in a normal state, a communication control system based on a distributed control function which requires a first waiting time as a transmission interval of data frame which is a unit of data to be transmitted while, due to an increase in a traffic of wireless medium, controlling transmission/reception of data to/from the mobile terminal by a communication control system based on a centralized control function system through polling, which requires a second waiting time as a transmission interval of the data frame that is shorter than the first waiting time, through providing an effective time during which the function operates, comprising the step of: calculating the total time required for performing transmission/reception of data to/from all the mobile terminals belonging to the wireless base station device for performing communication control by polling having the calculated time as the effective time for centralized control function when switching the communication control function from the distributed control function to the centralized control function due to an increase in a traffic of a wireless medium.

26. The communication control method as claimed in claim 24, further comprising the steps of: calculating the mean value of transmission/reception data size within a certain time; detecting a traffic increase in the wireless medium through judging whether or not the calculated average data size is larger than a threshold value; and switching the communication control system from the distributed control function to the centralized control function when the mean value is larger than the threshold value.

27. The communication control method as claimed in claim 24, further comprising the steps of: calculating an accumulated data rate, which is a proportion of uncompleted transmission number against data transmission request number calculated by the data transmission request number transmitted from the wireless base station device to the mobile terminals and the number of data which has been transmitted to the mobile terminal; detecting a traffic increase in the wireless medium through judging whether or not the calculated accumulated data rate is larger than a threshold value; and switching the communication control system from the distributed control function to the centralized control function when the accumulated data rate is larger than the threshold value.

28. The communication control method as claimed in claim 24, further comprising the steps of: timing the time corresponding to a frame interval of data frame continuously present on the wireless medium; detecting a traffic increase in the wireless medium through judging whether or not the obtained time corresponding to the frame interval is smaller than a threshold value; and switching the communication control system from the distributed control function to the centralized control function when the time corresponding to the frame interval becomes smaller than the threshold value.

29. The communication control method as claimed in claim 24, further comprising the step of: at the time of using the centralized control function, canceling a mobile terminal being in a state of power saving mode from authenticated mobile terminals which belong to the wireless base station device.

30. The communication control method as claimed in claim 21, wherein: the distributed control function is DCF (Distributed Coordination Function) defined by IEEE802.11; the centralized control function is PCF (Point Coordination Function) defined by the IEEE802.11; and the wireless base station control device switches the communication control system from the DCF to the PCF due to an increase in traffic of a wireless LAN.
